(19) United States
(12) Patent Application Publication
(10) Pub. No.: US 2011/0317134 A1
(43) Pub. Date: Dec. 29, 2011

(54) MODULAR STRUCTURE OF PICO PROJECTOR

(76) Inventors: SHIN-GWO SHIUE, Hu Kou Township (TW); David Tsai, Hu Kou Township (TW)

(21) Appl. No.: 12/821,158

(22) Filed: Jun. 23, 2010

(51) Int. Cl. G03B 21/28

(52) U.S. Cl. 353/98

(57) ABSTRACT

The structure of a projector contains a light path module, a projection lens module, a source lens module, a reflection mirror module, a reflection panel module, and a light source module. The light path module has a U-shaped body. The source lens module and the light source module are configured along a left side of the light path module. The projection lens module is configured along a right side of the light path module. The projection lens module is for projecting image to a screen. The source lens module is for modulating the light from the light source module. The reflection mirror module is installed at a left corner of the light path module to reflect the incident light from the light source module towards the reflection panel module. The reflection panel module is installed from the outside of a right corner of the light path module.

### (a) TECHNICAL FIELD OF THE INVENTION

The present invention generally relates to the manufacture and assembly of pico projectors, and more particular to a modular structure for a pico projector.

### (b) DESCRIPTION OF THE PRIOR ART

Generally, a product is designed to fulfill a specific requirement based on some available components of known specifications. Once the requirement is changed (taking projector as example, if a brighter light source or a longer projection range is needed), the project usually has to be redesigned in its entirety, causing significant waste of design cost and time.

For most components of a projector, there are increasingly more commercially available alternatives. To take advantage of this trend, and to achieve economic use of materials, cost saving, convenience, and versatility, modularizing a projector's structure seems to be a promising direction. A modular structure should be able to fulfill customer requirement in time and in most reliable manner, without sacrificing development cost and time.

Therefore, a major objective of the present invention is to turns the various functional components such as the lens, light source, reflection mirror, projection panel, etc. into optimally coupled modules so that they could be easily assembled in least amount of time with superior image quality.

In addition, the modular structure should only require modifications to few incompatible parts without altering the original functional design. As such, the latest customer and market demand could be conveniently addressed and fulfilled.

With the modular structure, some modules could be flexibly and conveniently replaced by alternative modules so as to fulfill the various requirements from different customers without redesigning.

### SUMMARY OF THE INVENTION

To achieve the foregoing objectives, the present invention breaks down the structure of a projector into six modules: a light path module, a projection lens module, a source lens module, a reflection mirror module, a reflection panel module, and a light source module. The light path module contains two pieces vertically joined to form a U-shaped body. A reserved space along a left side of the U-shaped light path module is configured with the source lens module and the light source module. Another reserved space along a right side of the U-shaped light path module is configured with the projection lens module.

The modular structure contains a light path module, a projection lens module, a source lens module, a reflection mirror module, a reflection panel module, and a light source module. The projection lens module in the right-side reserved space is an optical lens assembly for projecting image to a screen.

The modular structure contains a light path module, a projection lens module, a source lens module, a reflection mirror module, a reflection panel module, and a light source module. The source lens module in the left-side reserved space is an optical lens assembly for modulating the light from the light source module.

The modular structure contains a light path module, a projection lens module, a source lens module, a reflection mirror module, a reflection panel module, and a light source module. The reflection mirror module is installed at a slant inside of a left corner of the U-shaped light path module so as to reflect the incident light modulated by the source lens module towards the reflection panel module.

The modular structure contains a light path module, a projection lens module, a source lens module, a reflection mirror module, a reflection panel module, and a light source module. The reflection panel module is installed from the outside of a right corner of the U-shaped light path module that is normal to the projection lens module. By reflecting the light from the reflection mirror module, an image of the reflection panel module is projected to a screen through the projection lens module.

The modular structure contains a light path module, a projection lens module, a source lens module, a reflection mirror module, a reflection panel module, and a light source module. The light source module is configured at a start of the source light path, in front of the source lens module. The light source module projects light into the source lens module.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective break-down diagram showing the various components of a modular structure of a pica projector according to an embodiment of the present invention.

### DETAILED DESCRIPTION OF ME PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

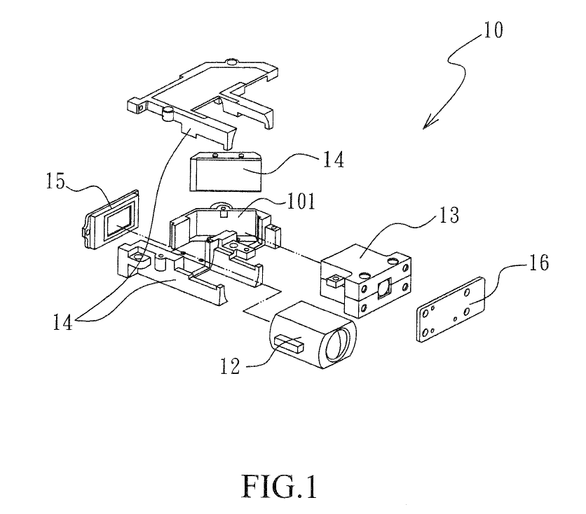

As shown in FIG. 1, a modular structure 10 of a pico projector according to an embodiment of the present invention contains a light path module 11, projection lens module 12, a source lens module 13, a reflection mirror module 14, a reflection panel module 15, and a light source module 16. The light path module 11 contains two pieces vertically joined to form a U-shaped body. A linear space to a left side of the U-shaped light path module 11 is reversed for the source light path (i.e., a light path from the light source), and is configured with the source lens module 13 and the light source module 16. Another linear space to a right side of the U-shaped light path module 11 is reserved for the projection light path (i.e., a light path to the projection lens), and is configured with the projection lens module 12. As described, a complete light path from the source light path to the projection light path is thus constructed.

The projection lens module 12 is an optical lens assembly for projecting image to a screen (not shown). The source lens module 13, on the other hand, is an optical lens assembly for modulating the light from the light source module 16. The projection and source lens modules 12 and 13 are therefore installed in the reserved space along the projection and source light paths, respectively.

The reflection mirror module 14 is installed at the slant inside 101 of a left corner of the U-shaped light path module 11 so as to reflect the incident light modulated by the source lens module 13 from the light source module 16 towards the reflection panel module 15. With such a design, the size of the projector is reduced for 50%. On the other hand, the reflection panel module 15 is installed from the outside of a right corner of the U-shaped light path module 11 that is normal to the projection lens module 12. As such, by reflecting the light from the reflection mirror module 14, an image of the reflection panel module 15 is projected to a screen (not shown) through the projection lens module 12.

The light source module 16 is configured at a start of the source light path, in front of the source lens module 13. The light source module 16, as such, projects light into the source lens module 13. The light source module 16 could utilize one or more light emitting diodes or laser generation elements.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A modular structure of a pico projector, comprising:
a light path module containing two pieces vertically joined to form a U-shaped body;
a source lens module which is an optical lens assembly configured along a left side of said light path module for modulating light from a light source module;
said light source module configured along said left side of said light path module in front of said source lens module for projecting light into said source lens module;
a projection lens module which is an optical lens assembly configured along a right side of said light path module for projecting image to a screen;
a reflection mirror module configured at a slant inside of a left corner of said light path module to reflect incident light modulated by said source lens module towards a reflection panel module; and
said reflection panel module configured from outside of a right corner of said light path module that is normal to said projection lens module, wherein an image of said reflection panel module is reflected and projected to said screen through said projection lens module.
